(19) United States
(12) Patent Application Publication
(10) Pub. No.: US 2010/0063658 A1
(43) Pub. Date: Mar. 11, 2010

(54) Engine Speed Control and Battery Power Scheduling Strategy for an Engine in a Hybrid Electric Vehicle Powertrain

(75) Inventors: Douglas Raymond Martin, Canton, MI (US); Jeffrey Matthew Jarvi, Westland, MI (US); Scott Anthony Greca, Saline, MI (US); Edward Badillo, Flat Rock, MI (US); Philip Joseph Wiethe, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/205,289

(22) Filed: Sep. 5, 2008

(51) Int. Cl. B60K 1/02

(52) U.S. Cl. 701/22; 477/3

(57) ABSTRACT

A control method and system is disclosed for regulating speed of an engine in a hybrid electric vehicle powertrain that includes an electric motor and gearing. An electrical power flow path and a mechanical power flow path are established. Electrical power is coordinated with mechanical power to effect an arbitrated engine speed for a given power demand that will result in an acceptable powertrain efficiency.

### BACKGROUND OF THE INVENTION

1. Field of the Invention

The invention relates to control of an engine in a hybrid electric vehicle powertrain with a divided power flow path from the engine and from an electric motor.

2. Background Art

In a hybrid electric vehicle (HEV) powertrain having an internal combustion engine and an electric motor, the power of each of these power sources may be distributed through separate torque flow paths to vehicle traction wheels, one path being a mechanical path and the other being an electro-mechanical path. The percentage of total power transferred to the vehicle traction wheels from each power source will vary depending upon the operating conditions for the vehicle, including driver demand for power and a state of charge of a battery that is electrically coupled to a vehicle traction motor and to an electric generator.

In a known hybrid electric vehicle powertrain of this type, the generator may be mechanically connected to the sun gear of a simple planetary gear unit, and a carrier may be drivably connected to an engine. The ring gear of the simple planetary gear unit is connected through gearing to the traction wheels. Engine speed can be controlled by controlling generator speed as the level of electro-mechanical power delivery is adjusted due to varying vehicle operating conditions.

In co-pending application Ser. No. 11/566,876, filed Dec. 5, 2006 entitled “System and Method for Controlling an Operating Temperature of a Catalyst of a Vehicle Exhaust System,” which is assigned to the assignee of the present invention, a known relationship between engine torque and engine speed may be used in determining a driver demand for power at the traction wheels. A desired threshold of engine power is related functionally to a predetermined temperature of a catalyst in the engine exhaust system. Power from the engine can be modified by supplying a power bias from the battery to reduce the portion of the total power supplied by the engine needed to meet the driver demand for power at the wheels. The temperature of the catalyst thus can be maintained below a predetermined threshold catalyst temperature. This eliminates the need for reducing catalyst temperature by enabling an air/fuel enrichment feature in a powertrain of this type, which would deteriorate the quality of engine exhaust gas emissions.

An operating strategy for controlling engine speed and torque values to meet a desired overall powertrain efficiency is disclosed in co-pending U.S. patent application Ser. No. 11/161,424, filed Aug. 2, 2005 entitled “Optimal Engine Operating Power Management Strategy for a Hybrid Electric Vehicle Powertrain,” which also is assigned to the assignee of the present invention. That operating strategy recognizes that engine efficiency has the most influence on total system efficiency, but highly efficient engine operation is not achieved at the expense of a lowering of the total system efficiency. The appropriate engine speed and torque values for obtaining maximum system efficiency is achieved by considering the efficiency of each of the components of the overall powertrain system. The power loss for each of the system components is obtained, and the engine speed is commanded so that it corresponds to the minimum value of the sum of the total powertrain system losses.

### SUMMARY OF AN EMBODIMENT OF THE INVENTION

In contrast to strategies of the type disclosed in the co-pending patent applications mentioned above, the disclosed embodiment of the invention improves the maximum efficiency over an entire trip by increasing battery usage during acceleration, which keeps the engine operating in a more efficient region in addition to improving NVH. It comprises a strategy for calculating a so-called battery power offset that is used to adjust target engine power command to yield a desired engine speed and vehicle speed relationship. This offset is limited by the capability of the battery and by other operating variables. That is, it is determined by the state of charge of the battery as well as variables such as battery temperatures, age of the battery and battery pack balance.

As in the case of the strategy of the co-pending applications mentioned above, the strategy of the present invention assumes that the engine is the primary power source. The strategy then will calculate in real time a variable engine power at the arbitrated target engine speed. The difference between the driver demanded power and the engine power at the arbitrated engine speed is the amount of battery power bias that the strategy requests. This battery offset augments the actual engine power to meet the demand for power at the traction wheels. Before this addition of a battery offset is made, the battery state of charge (SOC) and discharge power limits are taken into account.

Unlike known HEV control strategies, the strategy of the present invention achieves an appropriate engine power command without clipping the engine speed to compensate for a power shortfall. The strategy of the present invention thus will not disable the vehicle system controller's battery feedback and will not disable the vehicle system controller components that are dedicated to computing a desired engine speed. Further, the strategy of the invention will provide a powertrain calibrator with a simple and straightforward way to effect arbitration of operating variables to obtain an appropriate trade-off, for example, of powertrain fuel economy considerations and exhaust gas quality considerations.

A co-pending patent application related to the present application is U.S. Ser. No. 12/032,184, filed Feb. 15, 2008, which is assigned to the assignee of the present application. The '184 patent application discloses a power-based arbitration strategy for determining a battery power biasing request that effects good noise, vibration and harshness (NVH) in a HEV powertrain while taking into account a driver power demand, the engine power and engine speed for best efficiency, in battery power to maintain battery state of charge (SOC) and battery power needed to meet a driver demand for power. Unlike the strategy disclosed in the '814 patent application, the present invention is a speed-based arbitration strategy that determines the best engine speed for good NVH while taking into account the engine speed for peak instantaneous efficiency and a maximum allowed engine speed to maintain battery SOC.

### BRIEF DESCRIPTION OF THE DRAWINGS

FIG. 1 is a schematic view of a hybrid electric vehicle powertrain system having divided power flow paths between an engine and an electric motor through power transmitting gearing to vehicle traction wheels.

FIG. 1a is a schematic block diagram showing the power flow paths from the engine, and to and from the motor/generator battery subsystem.

FIGS. 1b through 1e are schematic diagrams of the power flow paths from the engine, and to and from the motor/generator subsystem for various powertrain operating states.

FIG. 2 is a plot showing the relationship between engine power and engine speed for the hybrid electric vehicle powertrain.

FIG. 3 is a plot that shows one relationship between vehicle speed and engine speed to effect best noise, vibration and harshness for a mid-range accelerator pedal position.

FIG. 3a is a plot showing one possible relationship between engine speed and vehicle speed for various driver operated accelerator pedal positions to achieve an engine speed for optimum noise, vibration and harshness (NVH) powertrain characteristics.

FIG. 3b is a plot that is similar to the plot of FIG. 3a wherein the ordinate has been lowered due to a lower battery SOC.

FIG. 4 is a block diagram of a power-based strategy for obtaining reduced NVH in a hybrid electric vehicle powertrain.

FIG. 4a is a block diagram of the overall control system for executing the strategy of the invention.

FIG. 4b is a plot of speed and torque for a typical internal combustion engine.

FIG. 5 is a plot of battery power available for various battery states-of-charge (SOC) up to a battery power discharge limit.

FIGS. 6 and 6a show a flow diagram that summarizes the strategy steps used in the speed-based control routine of the present invention.

### DETAILED DESCRIPTION OF AN EMBODIMENT OF THE INVENTION

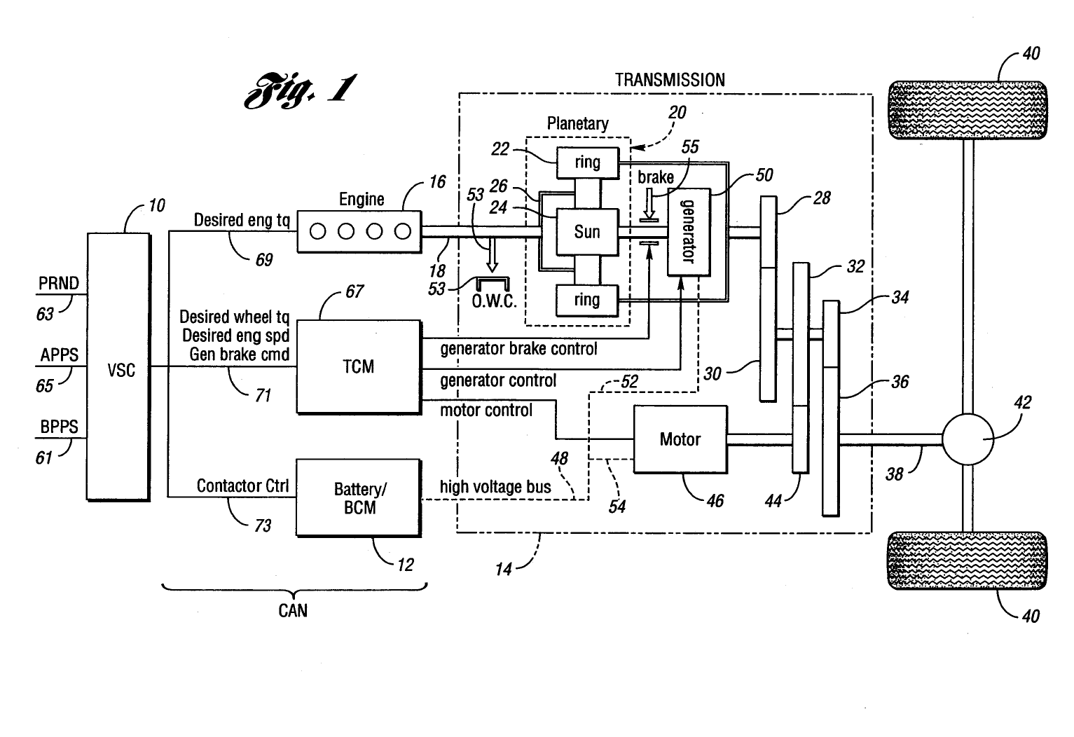

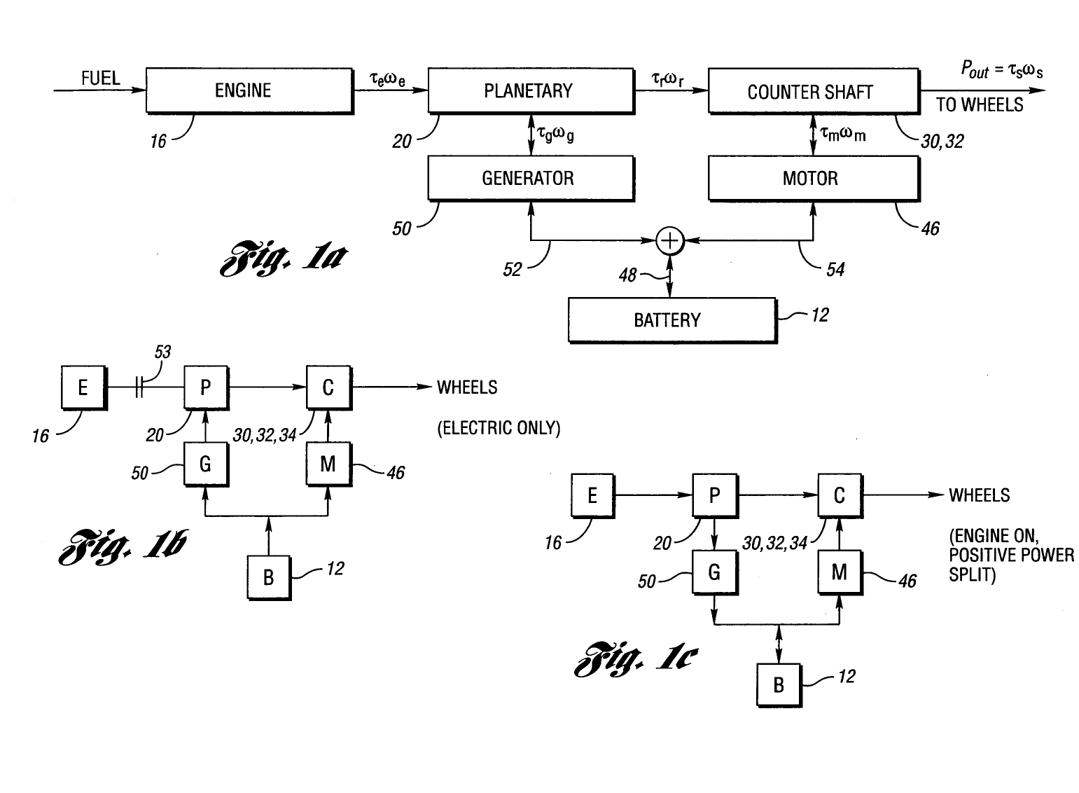

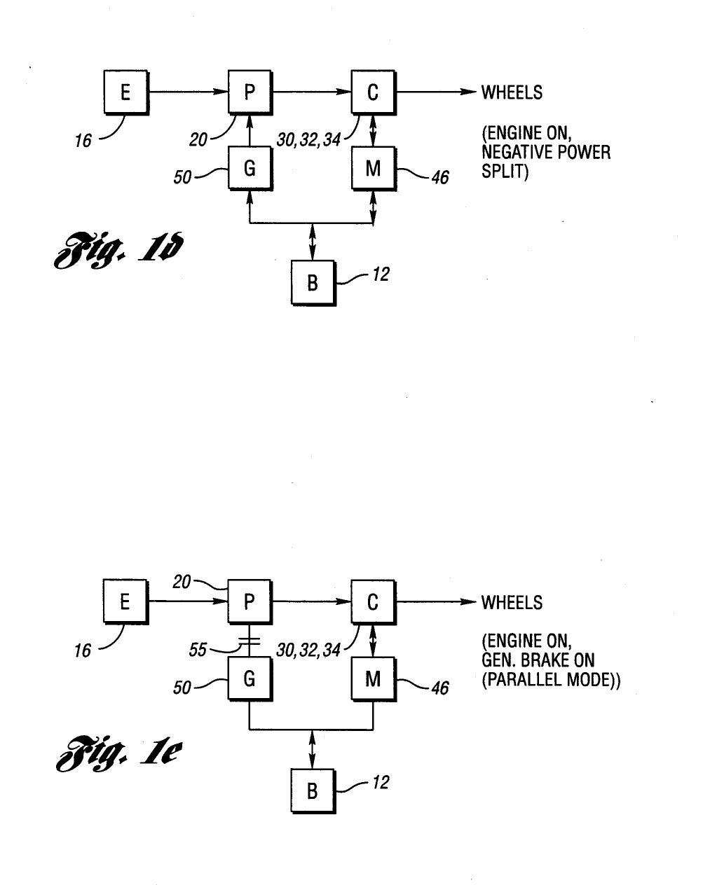

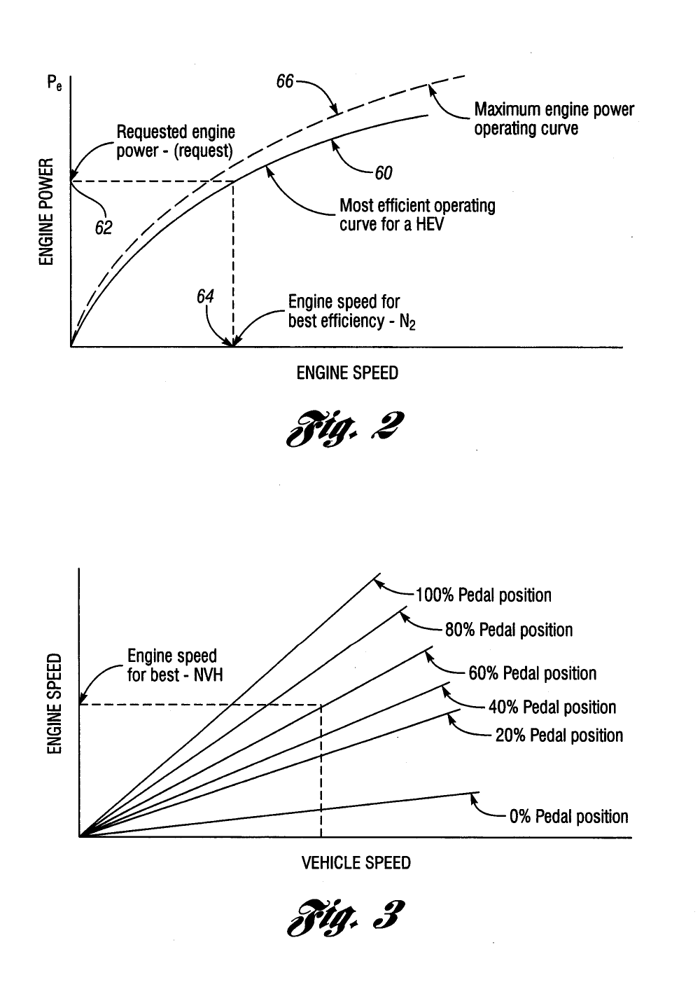

The present invention has features that relate to the invention of the co-pending '184 patent application previously discussed. The detailed description of an embodiment of the present invention, therefore, will include portions of the detailed description of the '184 patent application. Those portions refer to FIGS. 1-4.

The hybrid electric vehicle powertrain of one embodiment of the invention has a configuration as shown in FIG. 1. A vehicle system controller 10, a battery and battery control module 12 and a control module 67 for a transmission 14, together with a motor/generator subsystem, comprise a control area network (CAN). An engine 16, controlled by controller 10, distributes torque through torque input shaft 18 to transmission 14.

The transmission 14 includes a planetary gear unit 20, which comprises a ring gear 22, a sun gear 24, and a planetary carrier assembly 26. The ring gear 22 distributes torque to step ratio gears comprising meshing gear elements 28, 30, 32, 34 and 36. A torque output shaft 38 for the transaxle is drivably connected to vehicle traction wheels 40 through a differential-and-axle mechanism 42.

Gears 30, 32 and 34 are mounted on a countershaft, the gear 32 engaging a motor-driven gear 44. Electric motor 46 drives gear 44, which acts as a torque input for the countershaft gearing.

The battery of module 12 delivers electric power to the motor through power flow path 48. Generator 50 is connected electrically to the battery and to the motor in known fashion, as shown at 52.

Assuming that there is a battery power request for charging, that request will be considered to be a request for negative power. If the battery power request calls for discharging the battery, that request will be considered to be a request for positive power.

When the powertrain battery of module 12 is acting as a sole power source with the engine off, the torque input shaft 18 and the carrier assembly 26 are braked by an overrunning coupling 53. A mechanical brake 55 anchors the rotor of generator 50 and the sun gear 24 when the engine is on and the powertrain is in a parallel drive mode, the sun gear 24 acting as a reaction element.

In FIG. 1, the vehicle system controller 10 receives a signal at 63 from a transmission range selector, which is distributed to transmission control module 67, together with a desired wheel torque, a desired engine speed and a generator brake command, as shown at 71. A battery contactor or switch 73 is closed after a vehicle “key-on” startup. The controller 10 issues a desired engine torque request to engine 16, as shown at 69, which is dependent on accelerator pedal position sensor output 65.

A brake pedal position sensor distributes a wheel brake signal to controller 10, as shown at 61. The transmission control module issues a generator brake control signal to generator brake 55. It also distributes a generator control signal to generator 50.

As mentioned previously, there are two power sources for the driveline. The first power source is a combination of the engine and generator subsystems, which are connected together using the planetary gear unit 20. The other power source involves only the electric drive system including the motor, the generator and the battery, wherein the battery acts as an energy storage medium for the generator and the motor.

The power flow paths between the various elements of the powertrain diagram shown in FIG. 1 is illustrated in FIG. 1a. Fuel is delivered to the engine 16 under the control of the operator in known fashion using an engine accelerator pedal. Engine power delivered to the planetary gear unit 20 is expressed as τₑωₑ, where τₑ is engine torque and ωₑ is engine speed. Power delivered from the planetary ring gear to the countershaft gears is expressed as τᵣωᵣ, which is the product of ring gear torque and ring gear speed. Power out from the transmission 14 is represented by the symbols τₛ and ωₛ, the torque of shaft 38 and the speed of shaft 38, respectively.

The generator, when it is acting as a motor, can deliver power to the planetary gearing. Alternatively, it can be driven by the planetary gearing, as represented in FIG. 1a, by the power flow path 52. Similarly, power distribution between the motor and the countershaft gears can be distributed in either direction, as shown by the power flow path 54. Driving power from the battery or charging power to the battery is represented by the bi-directional arrow 48.

As shown in FIG. 1a, engine output power can be split into two paths by controlling the generator speed. The mechanical power flow path, τᵣωᵣ, is from the engine to the carrier to the ring gear to the countershaft. The electrical power flow path is from the engine to the generator to the motor to the countershaft. The engine power is split, whereby the engine speed is disassociated from the vehicle speed during a so-called positive split mode of operation. This condition is illustrated in FIG. 1c, where the engine 16 delivers power to the planetary gearing 20, which delivers power to the countershaft gears 30, 32 and 34, which in turn drive the wheels. A portion of the planetary gearing power is distributed to the generator 50, which delivers charging power to the battery at 12. The speed of the generator is greater than zero or positive, and the generator torque is less than zero. The battery drives the motor 46, which distributes power to the countershaft. This arrangement is a positive split.

If the generator, due to the mechanical properties of the planetary gear unit, acts as a power input to the planetary gear unit to drive the vehicle, the operating mode can be referred to as a negative split. This condition is shown in FIG. 1d where the generator speed is negative and the generator torque also is negative.

The generator in FIG. 1d delivers power to the planetary gear unit 20 as the motor 46 acts as a generator and the battery 12 is charging. It is possible, however, that under some conditions the motor may distribute power to the countershaft gearing if the resulting torque at the wheels from the gearing does not satisfy the driver demand. Then the motor must make up the difference.

If the generator brake 55 is activated, a parallel operating mode is established. This is shown in FIG. 1e, where the engine 16 is on and the generator is braked. The battery at 12 powers the motor 46, which powers the countershaft gearing simultaneously with delivery of power from the engine to the planetary gearing to the countershaft gearing.

The engine can deliver power only for forward propulsion because there is no reverse gear in the countershaft gearing. The engine requires either generator control or a generator brake to permit transfer of power to the wheels for forward motion.

The second source of power, previously described, is the battery, generator and motor subsystem. This is illustrated in FIG. 1b. In this driving mode, the engine is braked by the overrunning coupling 53. The electric motor draws power from the battery and effects propulsion independently of the engine, with either forward or reverse motion. The generator may draw power from the battery and drive against a reaction of the one-way coupling 53. The generator in this mode operates as a motor.

The control strategy of the present invention will cause the engine to operate, whenever that is possible, to satisfy the driver's demand for power even when the motor subsystem is inactive. This is done while maintaining the battery state-of-charge at or above a target value. Maintaining the state-of-charge at its target value will ensure that the other subsystems that use battery power are functioning normally and that the battery will not be overcharged or overdischarged.

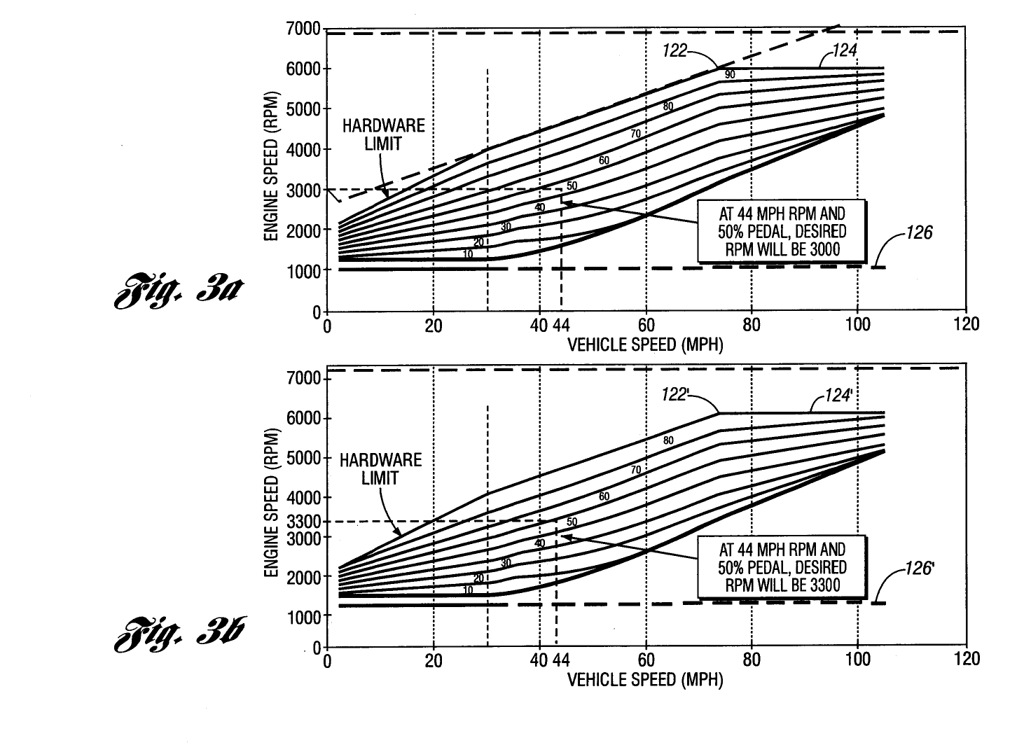

In executing the strategy of the present invention, it is necessary to establish an engine power and engine speed relationship that will result in the most efficient engine operating curve for a hybrid electric vehicle powertrain. An example of such a curve is illustrated in FIG. 2 at 60. It is stored in ROM registers of the VSC 10. The plot of FIG. 2 is a two-dimensional plot of engine power and vehicle speed for an engine in a HEV powertrain. A plot showing the maximum engine power operating curve with best efficiency for an engine of comparable capacity in a non-HEV powertrain is shown at 66. It is illustrated for purposes of comparing the parameters for the operating curve 60 with the parameters of an operating curve corresponding to a maximum engine power operation with best efficiency for a conventional powertrain.

Differences in the characteristic maximum engine power and engine speed plot for a conventional vehicle powertrain and a corresponding plot for a hybrid electric vehicle (HEV) powertrain are due in part to the fact that an engine with an Atkinson cycle, with its typical late valve opening feature, would likely be used in a HEV whereas an engine with an Otto cycle typically would be used in a conventional vehicle powertrain. Furthermore, an engine in a HEV typically would be smaller, and thus would operate in a higher speed range for a given power.

Reference may be made to previously mentioned co-pending patent application Ser. No. 11/161,424, filed Aug. 2, 2005 entitled “Optimum Engine Operating Power Management Strategy for a Hybrid Electric Vehicle Powertrain” for a description of a method for developing an optimal engine management strategy at a given target engine speed. The target engine speed is developed so that the total power system loss is a minimum. This is accomplished by minimizing the total system loss for each powertrain component. For any given engine speed command, there will be a computation of all of the power losses. The minimum value for these computations of power loss at a given engine speed command then is determined. The engine speed that will correspond to the minimum total power loss will not be the same as the engine speed that would correspond to a maximum engine efficiency, but it is a speed that corresponds to maximum total system efficiency.

In an alternate step of the control routine of the co-pending '424 patent application, it is possible to achieve a minimum total system loss by developing off-line, in a precalibration procedure, a look-up table that can be stored in read-only memory (ROM) of vehicle system controller 10, seen in FIG. 1. The look-up table will establish for every total power command and for each corresponding vehicle speed, a predetermined engine speed that will achieve minimum total powertrain losses. This results in maximum powertrain efficiency. The use of a table rather than a real time computation of losses may reduce the number of computations for the vehicle system controller 10 during each control loop of a central processor unit of controller 10. The individual calculations of power losses for the individual components of the powertrain can be eliminated and replaced by engine speed values computed off-line and pre-recorded in the look-up table.

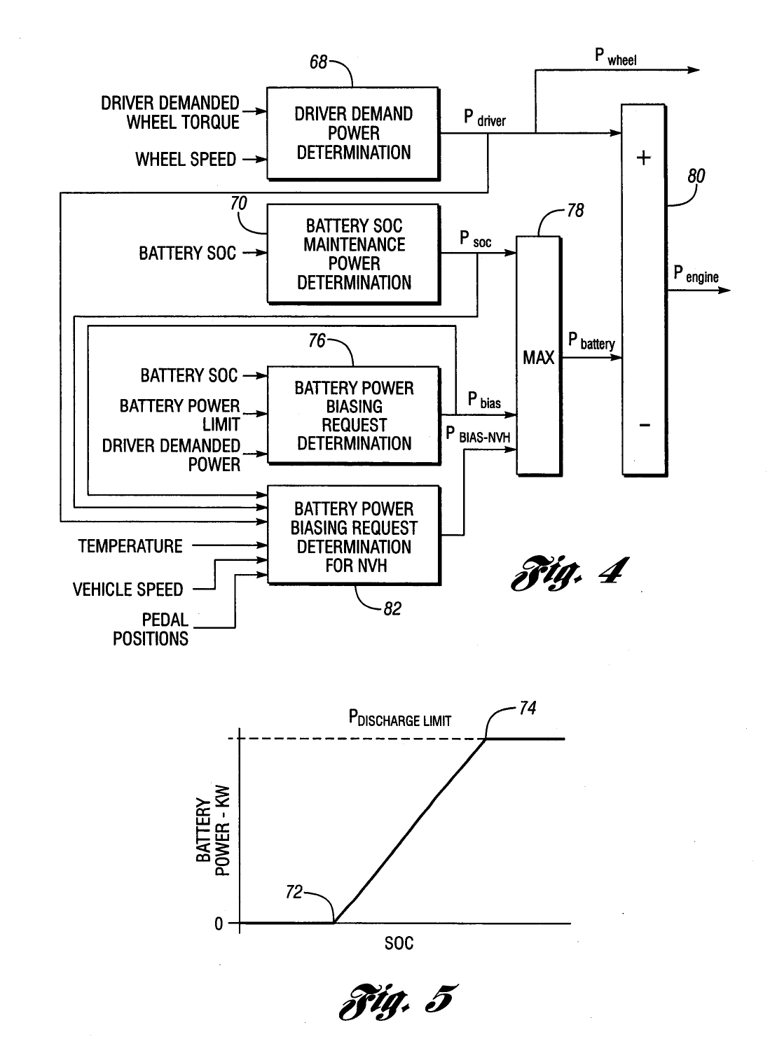

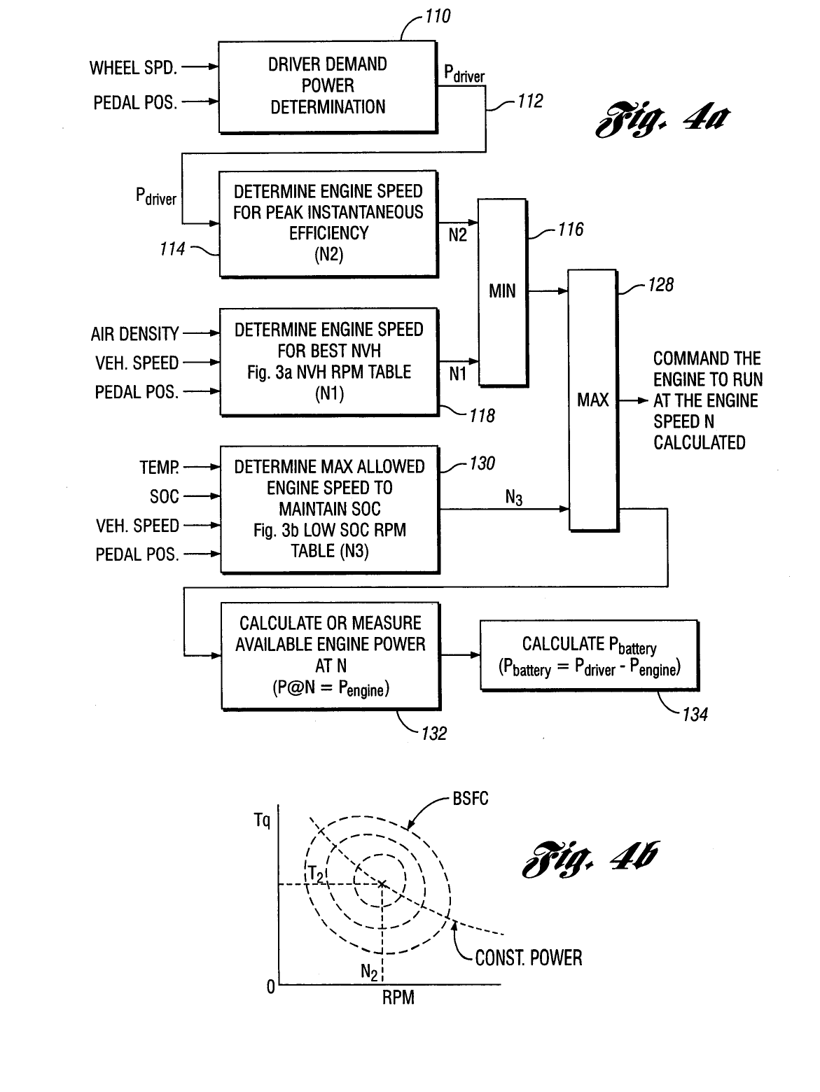

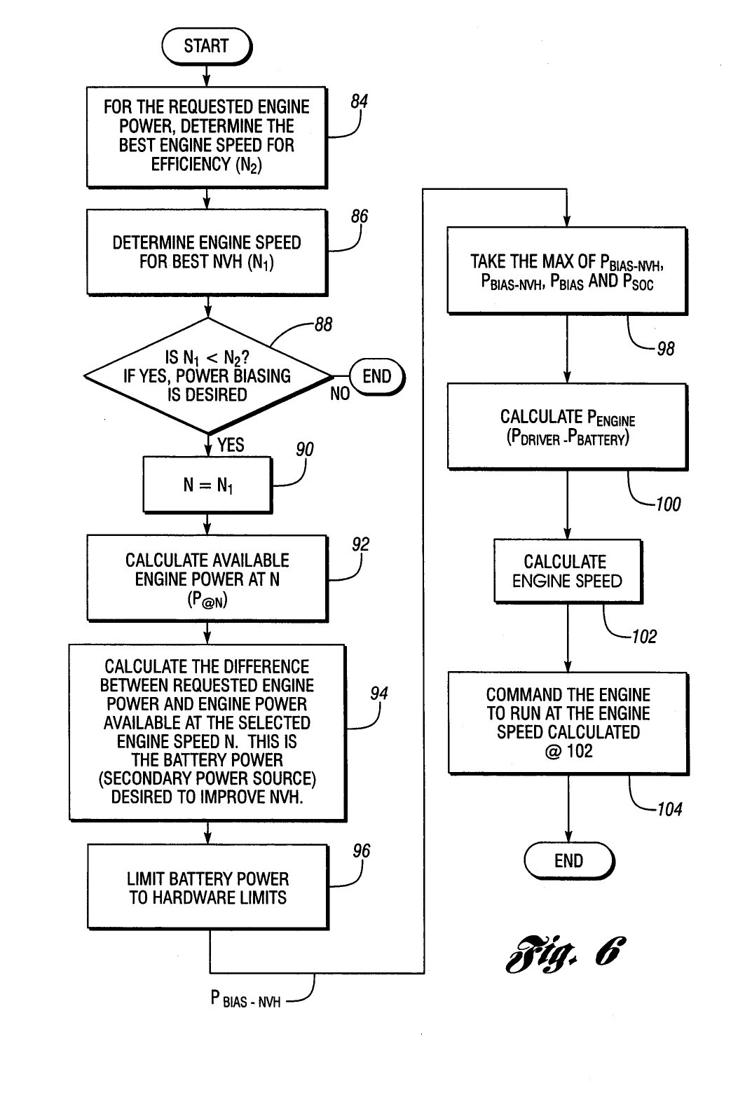

As seen in FIG. 4, the power request by the driver is determined at strategy control block 68. The driver demand, or request for power, is indicated in FIG. 4 by the symbol P_{driver}. The computations that occur at block 68 use as input a driver demanded wheel torque and a wheel speed. Wheel speed, which is a function of vehicle speed, can be related to engine speed as indicated in the plot of FIG. 3, where an engine speed N₁ that will achieve the best NVH characteristic is indicated for various accelerator pedal positions. The plot of FIG. 3 is an example of one of many possible precalibrated relationships between engine speed and vehicle speed that may be entered in memory for the vehicle system controller 10. Any given plot may take a shape quite different than the particular plot shown in FIG. 3. Further, other inputs may be used as well.

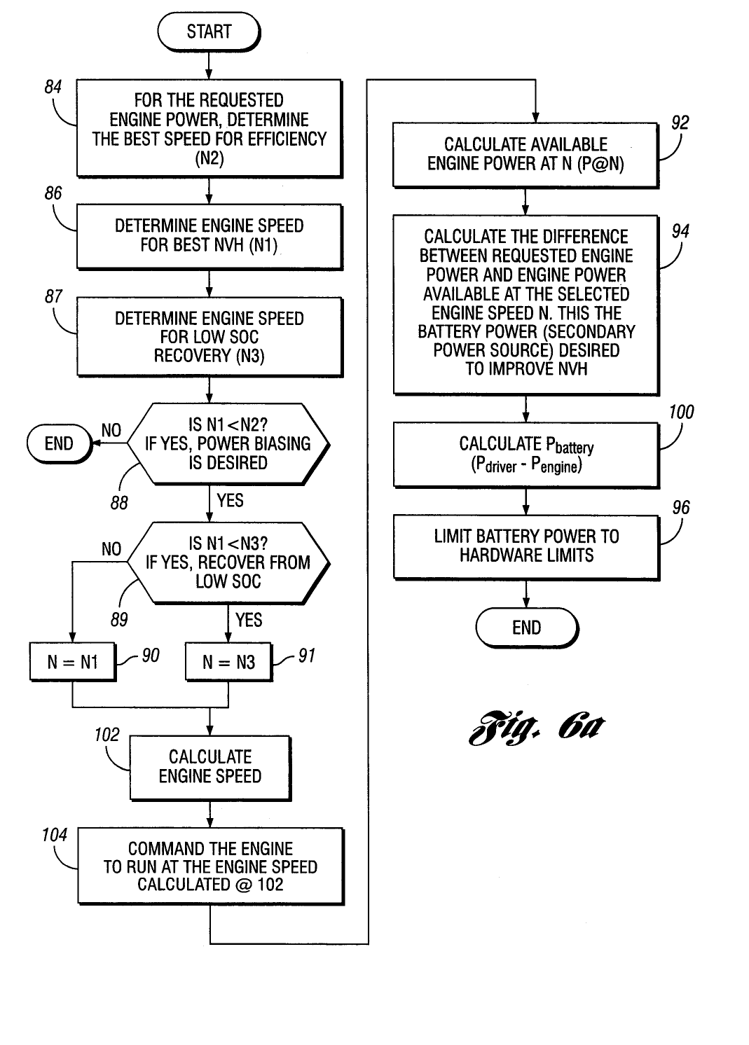

The schematic diagram of FIG. 4 also determines the battery SOC maintenance power determination for a given battery SOC. This occurs at block 70. Battery power is available within battery discharge power limits, which is indicated in FIG. 5. For any SOC in excess of a minimum value seen at 72 in FIG. 5, the battery power available increases relatively linearly until a discharge power limit value is reached at 74. The information in FIG. 5 is stored in controller memory and made available at block 70.

A target battery power is obtained by determining a difference between power at the wheels and power at the engine. If the power at the wheels is larger than the power at the engine, then the battery shown at 12 in FIG. 1 will be discharged. Further, if the power at the wheels is less than the power at the engine, power is stored in the battery 12.

FIG. 4 illustrates in block diagram form a strategy used by the controller to calculate power at the engine (P_{engine}), power at the wheels (P_{wheel}), and battery SOC to meet the driver demand for power and to maintain battery SOC. This is similar to the power-based strategy of co-pending patent application Ser. No. 12/032,184, filed Feb. 15, 2008, previously discussed. The difference between power at the wheels and power at the engine is controlled by the battery SOC maintenance power determination strategy at 70. This strategy will target a steady state battery power P_{SOC}. During normal operation P_{SOC} will be within a few percentage points of the target value.

At block 76 in FIG. 4 a battery power biasing request determination is made. Using inputs such as battery SOC, battery power limit and driver demanded power, this portion of the strategy will determine the power bias (P_{bias}) The values for P_{SOC} and P_{bias} are arbitrated at block 78, along with a power bias for reduced NVH, as will be described subsequently. The larger of the values for P_{SOC} and P_{bias} is selected at block 78 to produce a battery power value (P_{battery}) that is compared at block 80 to a driver request for power. The values are arbitrated at block 80 so that the driver demand for power is changed (e.g., reduced) by the amount of the power bias to produce an engine power command (P_{engine}). This power command will be of a value that will protect the engine exhaust system catalyst against exhaust gas temperatures that are too high. Exhaust gas temperatures that exceed a catalyst over-temperature protection value would trigger an enrichment of the air/fuel mixture. This is an undesirable condition since undesirable engine exhaust gas emissions would result.

The strategy routines executed at 68, 70 and 76 are disclosed in the previously discussed co-pending '876 patent application.

The strategy of FIG. 4 also includes a step for a battery power biasing request determination for optimum NVH. This occurs at block 82. The routine carried out at 82 provides an additional power bias variable for optimum NVH (P_{bias-NVH}). The inputs for the routine at 82 are the battery SOC, the previously described battery power bias P_{bias}, the driver demand for power (P_{driver}), etc. One of the inputs may be barometric pressure, although it is not shown in FIG. 4. The driver demand for power P_{driver} is the same as the power at the wheels (P_{wheel}). Other inputs that are used in a battery power biasing request determination for optimum NVH may be vehicle speed, pedal position, battery temperature, etc. Some of these inputs can be obtained, for example, using the relationships described with reference to FIGS. 2 and 3.

The power output P_{bias-NVH}, which is the result of the execution of the strategy at block 82, is distributed to block 78, where an arbitration or comparison is made between P_{SOC}, P_{bias} and P_{bias-NVH}. At block 78, a calculation is made to determine the maximum of the three inputs. That maximum is indicated by the symbol P_{battery}. This value is subtracted at block 80 from the driver demand for power to produce an engine power P_{engine}. This operating power level for the engine is used as a power command to develop an appropriate engine torque and speed.

FIG. 6 is a flowchart that shows the sequence of steps in the strategy routine. At action block 84, a determination is made of the engine speed N₂ needed for maximum efficiency at a requested engine power, as described previously with respect to FIG. 2. That step is followed by the routine at action block 86, where a determination is made of the engine speed N₁ for best NVH. At action block 88, it is determined whether the engine speed for best NVH is less than the engine speed for best efficiency. If the result of that inquiry is positive, battery power biasing is desired. That speed value then is treated as a commanded engine speed or target engine speed N, which is used at 90 to determine the available engine power at the target engine speed N. This occurs at action block 92 using the information in memory plotted in FIG. 2.

Following a determination of engine power available, the routine proceeds to action block 94 where the strategy will calculate a difference between the requested engine power and the engine power available at the target engine speed N. This is the battery power desired to improve NVH, which can be expressed as follows: P_{request}−P@N=P_{bias-NVH}.

The routine then proceeds to block 96, where the battery power determined at block 94 is tested to determine whether the battery power hardware limits are exceeded.

The output of the strategy routine at action block 96 is the power bias for best NVH (P_{bias-NVH}), which is made available to block 98 as seen in FIG. 4. At action block 98, the routine will take maximum values for P_{bias-NVH}, P_{bias} and P_{SOC}. Using that maximum value, the power at the battery is subtracted at action block 100 from the driver demanded power, as described with reference to FIG. 4, to produce an engine power value that takes into account the engine power needed for optimum NVH. That engine power is used to determine a speed command using the information in FIG. 2. This occurs at action block 102. The engine then is commanded at action block 104 to run at the engine speed determined at action block 102.

Unlike the power-based control strategy indicated in FIG. 4, the strategy of the present invention is a speed-based strategy which is illustrated in FIG. 4a. In the case of FIG. 4a, a driver demand for power is determined at step 110. The wheel speed is measured and is used as an input for the driver power demand determination. A power demand is determined also by pedal position, which is one of the inputs.

The driver power demand 112 is used as an input for step 114 which contains a precalibrated table showing the relationship between engine speed and efficiency. At step 114, the engine speed is chosen for peak instantaneous efficiency. That speed (N2) is distributed to action block 116 in the flow chart of FIG. 4a.

At step 118 in FIG. 4a, the engine speed is determined for best NVH. This also is a variable determined by a look-up table which is stored in ROM memory in the vehicle system controller 10. The data shown at 118 in FIG. 4a is illustrated in graphic form in FIG. 3a where engine speed is plotted for various vehicle speed values. In the plot of FIG. 3a, the relationship between vehicle speed and engine speed is generally linear between vehicle speeds of 30 miles per hour and approximately 75 miles per hour for various pedal positions. The pedal positions are indicated in FIG. 3 as a percentage of wide open throttle. For example, at 44 miles per hour, the speed limit for best NVH characteristics will vary along a vertical line shown at 120. At a fifty percent throttle setting, the engine speed for best NVH will occur at about 3,000 rpm engine speed, and at a 70% throttle position the engine speed for best NVH is about 4500 rpm. For each accelerator pedal position, the relationship between engine speed and vehicle speed may be approximately linear up to a breakpoint value. For maximum engine speed, the breakpoint value is shown at 122. At the breakpoint value, the slope of the relationship between engine speed and vehicle speed will be reduced. These breakpoints will allow an increase in engine speed without the need for providing a gear shift in the multiple ratio transmission. This characteristic will provide the driver with a better so-called “connected” drive feel or the driver will experience a familiar relationship between pedal position and vehicle speed.

In FIG. 3a, the limiting engine speed value is shown at 124 and the minimum engine speed limit is shown at 126.

The relationship between vehicle speed and engine speed is characteristic of a powertrain driving mode in which the battery operates with the normal state of charge (SOC). If the SOC is low, the plot of engine speed for various vehicle speeds will be raised as indicated in FIG. 3b. The shape of the plot of FIG. 3a may be similar to the shape of the plot of FIG. 3b, but the engine speed scale on the coordinate of the plot will be raised. For example, at 44 miles per hour and 50% pedal position, the desired engine speed will occur at 3300 rpm, whereas in the plot of FIG. 3a the desired engine speed for a vehicle speed of 44 miles per hour and 50% pedal position will occur at about 3000 rpm. A conventional engine efficiency plot of the kind shown in FIG. 4b may be used to determine the relationship of speed and torque that will result in best efficiency. The engine speed at a vehicle speed of 44 miles per hour for other pedal positions also will be raised, as indicated in FIG. 3b.

The engine speed for best NVH is identified in action block 114 in FIG. 4a by the symbol N1. The engine speed for best instantaneous efficiency is identified as N2. At action block 116, the value for engine speed N2 and engine speed N1 are compared, and the lesser of these two values is distributed to action block 128.

At step 130 in FIG. 4a, the maximum allowed engine speed to maintain SOC is determined when the SOC is low. This value is obtained from a table which is plotted in FIG. 3b. This value is identified in FIG. 4a by the symbol N3. The lesser engine speed value at 116 and the value N3 are distributed to action block 128 where they are compared. The greater of these two values is determined at action block 128. The engine is commanded to run at the engine speed calculated at action block 128.

If the battery SOC is low, the value of the available engine power at a speed of N3 is calculated at step 132. The battery power is available to provide a power bias that is calculated at 134. That battery power value is equal to the driver demanded power less engine power. The power at the wheels would be equal to the battery power plus engine power. If the battery SOC is low, a portion of the engine power would be used to charge the battery.

FIG. 6a is an overview of the entire operating strategy for the embodiment of the invention described in the preceding paragraphs. It includes steps that are common to this strategy described with reference to FIG. 6. The strategy steps described with reference to FIG. 6a that have a counterpart in the strategy described with reference to FIG. 6 have been illustrated by common numerals.

The strategy of FIG. 6a begins at step 84 where the engine speed for best efficiency for a requested engine power is shown at 84. That speed is identified as N2. In the next step at 86, the engine speed is determined for best efficiency. That value was identified as N1. At step 87, the engine speed is determined for low battery SOC recovery. That speed is referred to as N3.

At decision block 88, the values for N1 and N2 are compared. If N1 is less than N2, that indicates that power biasing is desired. If power biasing is desired, it is determined at decision block 89 whether N1 also is less than N3. If that is the case, the SOC recovery strategy is used, which means that at step 91 the engine speed is made equal to N3. If the battery SOC is not low, the value for engine speed that may be used would be equal to N1, as shown at 90.

If either N3 or N1 is used, the engine speed is calculated at 102 and the engine is commanded to run at the engine speed calculated at 102. This is seen at 104.

For the engine speed calculated at 102, an engine power at that speed is determined at action block 92. At action block 94, a difference between the requested engine power and the engine power available at the selected engine speed is calculated. This difference is supplied by the battery in order to obtain a desired NVH. The battery power is equal to the driver demanded power less the engine power as indicated at 100. A driver display in the vehicle passenger compartment will indicate a limiting value for battery power that would be determined by hardware limits. This is indicated at 96.

In determining the maximum allowed engine speed to maintain SOC when the battery SOC is low, the engine speed N3 is obtained by using a blending function for data illustrated in FIGS. 3a and 3b. The blending function is a common algebraic relationship of the data illustrated in graphic form in FIGS. 3a and 3b. This blending function can be expressed as follows:

N3=(F_{N}_{_{—}}_{SOC})*(FIG. 3b_{data})+(1−Fₙ_{_{—}}_{SOC})*(FIG. 3a_{data})

Although an embodiment of the invention has been disclosed, modifications will be apparent to persons skilled in the art. All such modifications and equivalents thereof are intended to be covered by the following claims.

What is claimed:

1. A control method for a hybrid electric vehicle powertrain having an engine and an electric motor, comprising the steps of:
determining engine speed (N1) for acceptable noise, vibration and harshness (NVH) characteristics for a given driver power demand;
determining an engine speed (N2) and torque for desirable instantaneous efficiency of the engine; and
commanding the engine to run at the lesser of engine speeds N1 and N2.

2. A control method for a hybrid electric vehicle powertrain having an engine and an electric motor, the motor complementing engine power to meet a driver demand for power at vehicle traction wheels, the method comprising the steps of:
determining driver power demand;
determining an engine speed (N2) and torque for desirable instantaneous efficiency of the engine;
determining engine speed (N1) for desirable noise, vibration and harshness (NVH) characteristics for a given driver power demand;
comparing engine speeds N1 and N2; and
commanding the engine to run at the lesser of engine speeds N1 and N2.

3. A control method for a hybrid electric vehicle powertrain having an engine and an electric motor, the motor complementing engine power to meet a driver demand for power at vehicle traction wheels and a battery electrically coupled to the motor, the method comprising the steps of:
determining engine speed N2 and torque for good powertrain efficiency;
determining engine speed (N1) for good noise, vibration and harshness (NVH) characteristics;
commanding the engine to run at the lesser of engine speeds N1 and N2;
measuring battery state of charge (SOC);
determining maximum allowed engine speed N3 needed to maintain SOC when SOC is less than a predetermined value;
calculating available engine power when SOC is less than a predetermined value;
calculating engine power available to charge the battery for a given driver demand for power; and
calculating battery power for the given driver demand for power and the calculated available engine power.

4. The control method set forth in claim 2, wherein the step of determining engine speed N2 comprises referring to a precalibrated relationship between engine efficiency and engine speed for a given engine torque.

5. The control method set forth in claim 3 wherein the method comprises the steps of:
determining engine speed N2 and torque for good powertrain efficiency;
determining engine speed (N1) for good noise, vibration and harshness (NVH) characteristics;
commanding the engine to run at the lesser of engine speeds N1 and N2;
measuring battery state of charge (SOC);
determining maximum allowed engine speed N3 needed to maintain SOC when SOC is less than a predetermined value;
calculating available engine power when SOC is less than a predetermined value;
calculating engine power available to charge the battery for a given driver demand for power; and
calculating battery power for the given driver demand for power and the calculated available engine power.

6. The control method set forth in claim 2, wherein the step of determining engine speed N1 comprises referring to a precalibrated relationship between engine efficiency and engine speed for a given engine torque demand.

7. The control method set forth in claim 2, wherein determining engine speed N1 is dependent on powertrain operating variables including vehicle speed and driver wheel power demand.

8. The control method set forth in claim 3, wherein determining engine speed N1 is dependent on powertrain operating variables including vehicle speed and driver wheel power demand.

9. The control method set forth in claim 2, wherein the step of determining engine speed (N3) comprises referring to a predetermined relationship between SOC, vehicle speed and driver wheel power demand.

10. The control method set forth in claim 3, wherein the step of calculating battery power for the given driver demand for power and the calculated available engine power includes limiting battery power to hardware limits.

11. An engine control system for a hybrid electric vehicle powertrain, comprising:
a controller configured to determine engine speed (N1) for acceptable noise, vibration and harshness (NVH) characteristics for a given driver power demand;
determine an engine speed (N2) and torque for desirable instantaneous efficiency of the engine; and
command the engine to run at the lesser of engine speeds N1 and N2.
